(19) United States
(12) Patent Application Publication
(10) Pub. No.: US 2014/0163856 A1
(43) Pub. Date: Jun. 12, 2014

(54) SENSING SYSTEM, SENSING METHOD, AND RECORDING MEDIUM THEREOF

(71) Applicant: Institute for Information Industry, Taipei City (TW)

(72) Inventors: Ying-Hsu CHEN, Kaohsiung City (TW); Ren-Dar YANG, Hsinchu City (TW)

(73) Assignee: Institute for Information Industry, Taipei City (TW)

(21) Appl. No.: 13/900,124

(22) Filed: May 22, 2013

(30) Foreign Application Priority Data
Dec. 7, 2012 (TW) 101146071

(51) Int. Cl. G06F 17/00

(52) U.S. Cl. CPC G06F 17/00
USPC 701/300

(57) ABSTRACT

A sensing system, a sensing method, and a recording medium thereof are provided, which are applicable to a sensing area formed of at least four boundary lines, in which neighboring boundary lines are at a straight angle, and each boundary line is at least three sensing points are set thereupon. Each sensing point implies a coordinate on XY plane. Each sensor provides a sensed value, location information and coordinate corresponding to a sensing point. The processor gets sensed values corresponding to all sensing points from the sensors, and estimates the estimated values of a plurality of expected estimated boundary points on each boundary line according to one of a plurality of estimation formulas and the sensed values of the three sensing points on each boundary line, in which the distance between each expected estimated boundary point and its other neighboring expected estimated boundary points is within a preset value.

### CROSS-REFERENCE TO RELATED APPLICATION

This application claims the benefit of Taiwan Patent Application No. 101146071, filed on Dec. 7, 2012, which is hereby incorporated by reference for all purposes as if fully set forth herein.

### BACKGROUND OF THE INVENTION

1. Field of Invention

The present invention relates to a sensing system, a sensing method, and a recording medium thereof, and more particularly to a sensing system, a sensing method, and a recording medium thereof that estimate sensed values for other locations in a sensing area formed of at least four boundary lines through sensed values of sensing points on the at least four boundary lines.

2. Related Art

In the prior art, during plant cultivation, to learn the changes of a cultivation environment and analyze the growth conditions of plants, sensors are placed at several locations in the cultivation environment. However, the placement density of sensors is related to the changes of environment and the accuracy of analysis. Therefore, manufacturers usually allocate a large number of sensors in a cultivation environment in a scattered manner.

However, in a cultivation environment for cultivating a large number of seedlings, in consideration of factors such as the cost and plant order types, manufacturers mix different plants based on priorities and control environmental factors to cultivate different plants in one same environment, which results in uneven environmental parameters in the cultivation environment. Also, according to different environments required for plants, manufacturers allocate different number of sensors according to the types of plants and environmental conditions and the allocated density of sensors also varies. In the case of a small number of sensors, it is often not easy to precisely measure practical data in a cultivation environment, therefore making it difficult to control the cultivation environment. To obtain practical data in a cultivation environment, usually the number of sensors is increased or the allocated density of sensors is raised nowadays. When a large field area is to be monitored, a huge number of sensors are required, which greatly increases the building cost.

### SUMMARY OF THE INVENTION

The object of the present invention is to provide a sensing system, a sensing method, and a recording medium thereof, so as to estimate an estimated value for each estimation location point in a sensing area according to sensed values corresponding to sensors in the sensing area.

The sensing system disclosed, in the present invention is applicable to a sensing area formed of at least four boundary lines, in which each boundary line forms a straight angle with other boundary lines connected thereto, each boundary line is at least three sensing points are set on it, and each sensing point implies a coordinate on XY plane. The system comprises at least one sensor and at least one processor. The sensor comprises a sensing unit, a locating unit, a storage unit, and a processing unit.

The locating unit is used for generating location information of the sensor. The storage unit stores each sensing point and the coordinates on the XY plane corresponding thereto. The processing unit determines that the location information and the coordinate corresponding to one sensing point among the sensing points is within a specified range, launches the sensing unit to get a sensed value, and records the sensed value and the corresponding sensing point when the sensing unit is launched.

The processor is coupled to the at least one sensor to get a plurality of sensed values recorded in each sensor and the corresponding sensing point, and then estimate estimated values of a plurality of expected estimated boundary points on each boundary line according to one of a plurality of estimation formulas and the sensed values of the three sensing points on each boundary line, in which the distance between each expected estimated boundary point and other neighboring expected estimated boundary points is within a preset value.

The sensing method disclosed in the present invention is applicable to a sensing area formed of at least four boundary lines, in which each boundary line forms a straight angle with other boundary lines connected thereto, each boundary line is at least three sensing points are set on it, and each sensing point implies a coordinate on XY plane. The method comprises: getting, by a sensor, location information of the sensor at any sensing point; when the sensor determines that the location information and the coordinate of one sensing point among the sensing points is within a specified range, getting a sensed value, and recording the sensed value and sensing point during the acquisition of the sensed value; getting, by a processor sensor, the recorded plurality of sensed values and the corresponding sensing points during the acquisition of the sensed values; and, estimating, by the processor, estimated values of a plurality of expected estimated boundary points on each boundary line according to one of a plurality of estimation formulas and the sensed values of the three sensing points on each boundary line, in which the distance between each expected estimated boundary point and other neighboring expected estimated boundary points is within a preset value.

The present invention also discloses a non-immediately recording medium, which stores a program code readable by an electronic device. When reading the program code, the electronic device executes a sensing method. The sensing method is applicable to a sensing area formed of at least four boundary lines, in which each boundary line forms a straight angle with other boundary lines connected thereto, each boundary line is at least three sensing points are set on it, and each sensing point implies a coordinate on XY plane. The method is as discussed above.

First, the present invention estimates the estimated value of each estimation point in a sensing area through sensed values got by a limited number of sensors on a boundary line of the sensing area, which is capable of reducing the arrangement cost of hardware. Secondly, the estimation of estimated value is performed in each axial direction in the XY plane in combination a suitable estimation formula, and the got estimated values satisfy the practical sensed values. Thirdly, the estimation of estimated value is performed in each axial direction in the XY plane in combination with a suitable estimation formula, which is therefore applicable to a sensing area with different environmental factors and is capable of enhancing the applicability of the system. Fourthly, most sensed values are estimated, so that only a small number of times of signal collection and conversion work are required, thereby enhancing the speed of the entire sensing work. Fifthly, the present invention does not require significant changes to hardware to become applicable to existing sensing systems, so the arrangement cost of hardware is reduced and also the applicability of the system is enhanced.

### BRIEF DESCRIPTION OF THE DRAWINGS

The present invention will become more fully understood from the detailed description given herein below for illustration only, and thus are not limitative of the present invention, and wherein:

FIG. 1 is a schematic system diagram of a sensing system according to an embodiment of the present invention;

FIG. 2 is a schematic diagram of the arrangement of sensing points in a sensing area of a sensing system according to an embodiment of the present invention;

FIG. 3 is a schematic flow chart of a sensing method according to an embodiment of the present invention;

FIG. 4 and FIG. 5 are detailed flow charts of a sensing method according to the embodiments of the present invention; and

FIG. 6 is a schematic flow chart of a sensing calibration method according to an embodiment of the present invention.

### DETAILED DESCRIPTION OF THE INVENTION

The preferred embodiments of the present invention are described in detail below with reference to the accompanying drawings.

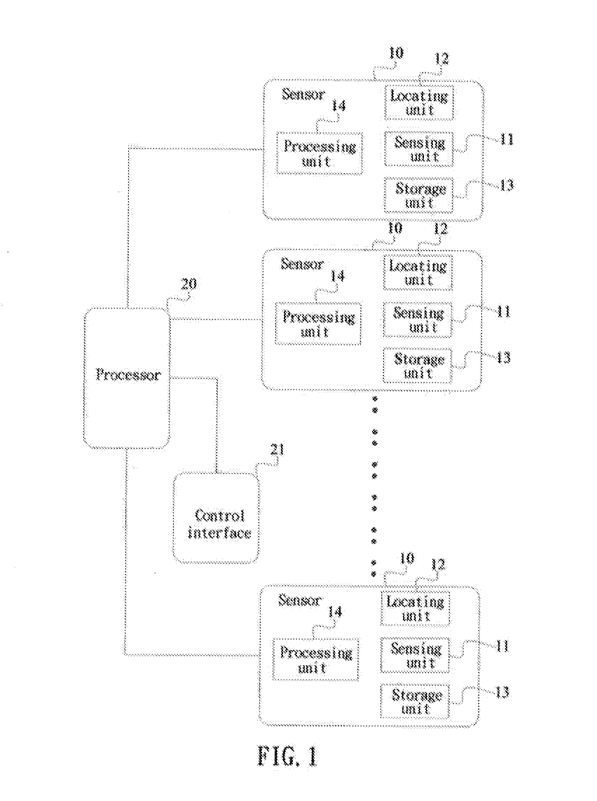

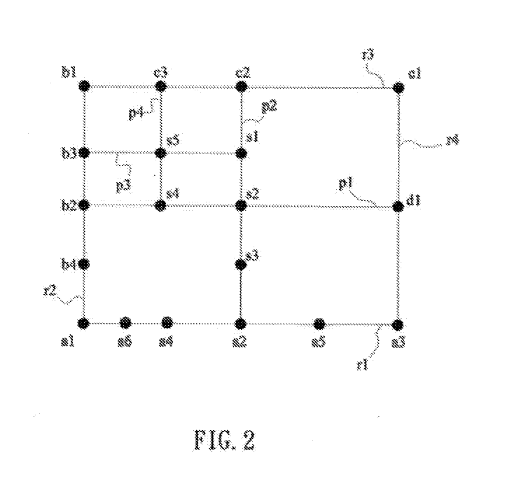

FIG. 1 is a schematic system diagram of a sensing system according to an embodiment of the present invention. FIG. 2 is a schematic diagram of the arrangement of sensing points in a sensing area of a sensing system according to an embodiment of the present invention. Please refer to FIG. 1 and FIG. 2 at the same time, the sensing system may be arranged in a cultivation range with a regular or irregular shape, one sensing area is arranged in the cultivation range, and the sensing area is formed by four or more boundary lines. Each boundary line forms a straight angle with other boundary lines connected thereto. Therefore, regardless of the number of boundary lines, more than one square shape is formed in the sensing area. Each boundary line is at least three sensing points are set on it, and each sensing point implies a coordinate on XY plane. The distances between neighbor sensing points may be equal or may be unequal, and in a preferred embodiment, equal distances can be adopted.

The sensing system includes at least one sensor 10 and at least one processor 20. The sensor 10 includes a sensing unit 11, a locating unit 12, a storage unit 13, and a processing unit 14.

The sensing unit 11 is used for providing a sensed value and may be any type of sensing element or device such as a thermometer, an illuminometer, and a hygrometer used for sensing the air components, soil components, temperature, humidity, illuminance, pH, light rays, infrared, body temperature, the concentration of carbon dioxide, the concentration of carbon monoxide, the concentration of oxygen, sound, and the like; however, the present invention is not limited thereto.

The locating unit 12 is used for generating location information of the sensor 10, for example, the latitude and longitude data of the sensor 10 or the relative coordinate data of the sensor 10 in the sensing area. The locating unit 12 may be a common element or device in the prior art, such as the Global Positioning System (GPS), the Assisted GPS (AGPS), Google Latitude, and mobile phone locating (the geographical location of a mobile phone user is computed by means of the characteristic that a mobile phone base station or a wireless network base station (Wi-Fi AP) transmits signals at a fixed location); however, the present invention is not limited thereto. More specifically, the sensor 10 may be one movable device that moves through various mechanism designs or being carried by a person, and then the locating unit 12 performs locating to generate the location information of the sensor 10.

The storage unit is used for storing the data of each sensing point and the coordinate of each sensing point.

The processing unit 14 compares the location information with the coordinate of each one sensing point, and once determining that the difference between the location of the sensor 10 and the coordinate of a sensing point among the multiple sensing points is within one specified range (for example, the distance thereof from the coordinate is 30 centimeters), starts the sensing unit 11 to perform sensing to obtain the sensed value. The processing unit 14 gets the sensed value provided by the sensing unit 11, and records the sensed value and the corresponding sensing point when the sensing unit 11 is launched. The values may be recorded in the storage unit 13 or stored in the memory space of the processing unit 14. For example, when the sensor 10 is very close to any sensing point, the processing unit 14 may generate one start signal and transmit the start signal to the sensing unit 11 to start the sensing unit 11 to perform sensing, and perform storage. When multiple sensing points and the corresponding sensed values thereof are stored, they are transferred to the processor 20 to perform subsequent processing. In some specific embodiments, the locating unit 12 may further display the location information of the sensor 10 at a display unit (not shown in FIG. 1) through an electronic map, and the processing unit 14 may further display an operation interface or provide a function for people to operate or confirm on the electronic map through the display unit and then start the sensing unit 11 to perform sensing.

The processor 20 may be any processing unit, chip, and integrated circuit having a computational capability or data processing capability, or hardware with a computational capability such as a computational circuit, device, component, and equipment; or software that is operated in combination with hardware, such as a computational system, a program or firmware for the operation of a chip, an integrated circuit, and the like. The manner by which the processor 20 is coupled to the sensor 10 includes a wired network, a wireless network, a circuit wire, a connection port, or any connection means that is related to a data transmission capability. The processor 20 gets a plurality of sensed values from the sensor 10 and the sensing point corresponding to each sensed value, in which the sensing points correspond to the places where the sensing unit is launched.

The processor 20 estimates estimated values of a plurality of expected estimated boundary points on each boundary line according to the sensed values of three sensing points on each boundary line and according to one of a plurality of estimation formulas. The distance between each expected estimated boundary point and other neighboring expected estimated boundary points is within one preset value. In a specific embodiment, and the preset value may be decided based on one default parameter for the computation of the processor 20 according to practical demands or a general empirical value of a sensing area, or may be set by user through one control interface 21.

Before the estimation computation of expected estimated boundary points, the processor 20 may select one from the plurality of estimation formulas as the estimation formula corresponding to the boundary line, and multiple selection manners may be adopted. For example, in FIG. 2, it is assumed that the processor 20 intends to select the estimation formula for the first boundary line r1 in the X-axis direction, the processor 20 may first get the sensed values corresponding to the sensing point a1, sensing point a2, and sensing point a3. The processor 20 selects one of the sensing point a1, sensing point a2, and sensing point a3 as a specified sensing point. For example, the sensing point a2 is temporarily set as the specified sensing point. Subsequently, the processor 20 may use each estimation formula and the sensed values of the sensing point a1 and the sensing point a3 to calculate the estimated value of the sensing point a2, respectively, then compares estimated value with the practical sensed value of the sensing point a2 to find the estimated value closest to the sensed value of the sensing point a2, and uses the estimation formula corresponding to the estimated value as the estimation formula for the first boundary line r1.

Next, the processor 20 calculates the estimated value corresponding to the expected estimated boundary point a4 according to the sensed values corresponding to the sensing point a1 and the sensing point a2 and the estimation formula for the first boundary line r1; calculates the estimated value corresponding to the expected estimated boundary point a5 according to the sensed values corresponding to the sensing point a2 and the sensing point a3 and the estimation formula for the first boundary line r1; and calculates the estimated value corresponding to the expected estimated boundary point a6 according to the sensed value corresponding to the sensing point a1, the estimated value corresponding to the expected estimated boundary point a4, and the estimation formula for the first boundary line r1; and the like. In this manner, the estimated values corresponding to all expected estimated boundary points of the first boundary line r1 are calculated. The estimation formula that the processor 20 estimates the estimated value of the expected estimated boundary point is value interpolation. The value interpolation includes a combination formed of at least one of constant interpolation, Bézier curve interpolation, continuous interpolation, exponential interpolation, logarithmic interpolation, linear interpolation, neighbor interpolation, bilinear interpolation, and bicubic interpolation.

During the previous work, the specified sensing point is not a sensing point on the boundary line, that is to say, when the sensor 10 does not perform measurement at the location of the specified sensing point, the sensor 10 needs to get the sensed value corresponding to the specified sensing point first. Similarly, as shown in FIG. 2, the processor 20 performs computation for the second boundary line r2 in the Y-axis direction. When one of the sensing points on the boundary line is set on the intersection of more than two boundary lines, the sensing point may be seen as the sensing points of the two neighboring boundary lines at the same time. For example, the sensing point a1 may be seen as the sensing points of the first boundary line r1 and second boundary line r2 at the same time.

The processor 20 gets from the sensor 10 sensed values corresponding to the sensing point a1, sensing point b1, and sensing point b2. The processor 20 selects one of the sensing point a1, sensing point b1, and sensing point b2 as the specified sensing point, gets the estimation formula for the second boundary line r2 according to the above manner, and then estimates all estimation points on the second boundary line r2. For example: according to the sensed values corresponding to the sensing point b1 and the sensing point b2, in combination with the estimation formula for the second boundary line r2, the estimated value corresponding to the expected estimated boundary point b3 is calculated; according to the sensed values corresponding to the sensing point a1 and the sensing point b2, in combination with the estimation formula for the second boundary line r2, the estimated value corresponding to the expected estimated boundary point b4 is calculated; and the like. In this manner, the processor 20 is capable of calculating the estimated values corresponding to all expected estimated boundary points of the second boundary line r2.

In a similar way, the processor 20 is capable of calculating the estimated values corresponding to all expected estimated boundary points on the third boundary line r3 in the X-axis direction, and calculating the estimated values corresponding to all expected estimated boundary points on the fourth boundary line r4 in the Y-axis direction. However, in some embodiments, the expected estimated boundary points may also be set on the intersection of two neighboring boundary lines, and it is assumed to be the expected estimated boundary point c1. After getting the estimation formulas for the third boundary line r3 and the fourth boundary line r4, the processor 20 estimates two estimated values corresponding to the expected estimated boundary point c1 through the two estimation formulas, respectively. The processor 20 may get a computation manner using the mean value of the two estimated values or either of the two, so as to get the estimated value of the expected estimated boundary point c1.

In some other embodiments, a plurality of expected estimated plane points may be set in the sensing area, that is, points to be estimated that are not on a boundary line. The processor 20 is further used for estimating the estimated value of each expected estimated plane point according to the sensed values of a plurality of sensing points on each boundary line and the estimated values of a plurality of expected estimated boundary points, and one of a plurality of estimation formulas. The manner of estimating an expected estimated plane point is illustrated as follows.

By taking FIG. 2 as an example, when the estimated values of points to be estimated on all boundary lines (for example, r1 to r4) have been estimated, subsequently, a specified sensing point (for example, s2) may further be set in the sensing area. The specified sensing point is located at a median line of the field (for example, p2) that is parallel to any boundary line (for example, r2) of the at least four boundary lines and whose two end points are located at other two boundary lines (for example, r1 and r3), and the median line of the field may be further set with a plurality of expected estimated plane points (for example, s1, s3). Subsequently, the sensor 10 may be further used for sensing the sensed value of the specified sensing point (s2). Next, the processor 20 may estimate the estimated values of the expected estimated plane points (for example, s1 and s3) on the median line of the field (for example, p2) according to the sensed value of the specified sensing point (s2), the sensed values of the sensing points (which may also be the estimated values of the points to be estimated) corresponding to the two end points (for example, a2 and c2) of the median line of the field (for example, p2), and one of a plurality of estimation formulas.

In another embodiment, by taking FIG. 2 as an example again, when an expected estimated plane point is set between two boundary lines parallel to the axial direction, for example, for the expected estimated plane points s1, s2, s3, and the like, the expected estimated plane points are arranged between the first boundary line r1 and the third boundary line r3 and are located at the second line segment p2 of the median line of the field formed by the sensing point c2 and the sensing point a2. The processor 20 may first get the sensed values corresponding to the sensing point a2 and the sensing point c2 according to the above manner and current it is set that the specified sensing point is the expected estimated plane point s2, and the sensor 10 is used for sensing the sensed value of the specified sensing point s2. The processor 20 may calculate the estimated value of the sensing point s2 by using each estimation formula, respectively, find the estimated value closest to the sensed value of the specified sensing point s2, and use the estimation formula corresponding to the estimated value as the estimation formula for the second line segment p2 of the median line of the field.

The processor 20 then estimates the estimated values corresponding to the expected estimated plane points s1, s3, and the like according to the sensed values corresponding to the sensing point a2, the sensing point c2, and the specified sensing point s2, and the estimation formula for the first line segment p2 of the median line of the field. Similarly, the processor 20 also estimates the first line segment p1 of the median line of the field formed by the sensing point b2 and the sensing point d1 and the estimated values corresponding to all expected estimated plane points on the first line segment p1 of the median line of the field. However, the expected estimated plane point s2 is also located on the second line segment p2 of the median line of the field, which therefore can also be used as the specified sensing point s2 of the second line segment p2 of the median line of the field and used for deciding the estimation formula for the second line segment p2 of the median line of the field.

Furthermore, the estimated values of other expected estimated plane points may also be calculated. Please refer to the portion of sensing area in FIG. 2, for example, the area formed of four points b1, b2, s2, and c2. As the sensed values or estimated values corresponding to the 4 points are all known, and the processor 20 may get the mean value of s5 according to the mean value of four points b1, b2, s2, and c2 to replace the sensed value of s5. The points b3, c3, s1, and s4 are sensing points or points to be estimated with known values, so that the processor 20 may calculate the estimated value of s5 according to the sensed values or estimated values of b3 and s1 by using each estimation formula, respectively, find the estimated value closest to the mean value of s5 (in place of the sensed value of s5), decide the estimation formula for the third line segment p3 of the median line of the field, and then calculate the estimated values of other expected estimated plane points on the third line segment p3 of the median line of the field according to the estimation formula. By repeating the above steps, the estimated values of all expected estimated plane points in the sensing area may be estimated one by one.

That is to say, the second boundary line r2, the third boundary line r3, the first line segment p1, and the second line segment p2 intersect with each other and form a sensing area formed by the sensing point b1, the sensing point b2, the sensing point c2, and the expected estimated plane point s2. The second boundary line r2, the third boundary line r3, the first line segment p1, and the second line segment p2 are considered as the “boundary lines” of this sensing area.

The processor 20 gets the sensed value corresponding to the sensing point b3 according to the sensed values corresponding to the sensing point b1 and the sensing point b2 and the estimation formula for the second boundary line r2, and gets the estimated value corresponding to the expected estimated plane point s1 according to the sensed value corresponding to the sensing point c2, the estimated value corresponding to the expected estimated plane point s2, and the estimation formula for the second line segment p2. These sensed values and estimated values can be got during the previous sensing or estimation work. The processor 20 gets the estimation formula for the third line segment p3 of the median line of the field formed by connecting the expected estimated plane point s1 and the expected estimated boundary point b3 according to the above manner. The processor then gets the estimated value corresponding to the expected estimated plane point s5 based on the estimated values corresponding to the expected estimated plane point s1 and the expected estimated boundary point b3 and the estimation formula for the third line segment p3.

Alternatively, the processor 20 gets the estimated values corresponding to the expected estimated boundary point c3 and the expected estimated plane point s4 on the fourth line segment p4 and the estimation formula for the fourth line segment p4 formed by connecting the expected estimated plane point s4 and the expected estimated boundary point c3. The processor 20 then gets the estimated value corresponding to the expected estimated plane point s5 based on the estimated values corresponding to the expected estimated plane point s1 and the expected estimated boundary point b3 and the estimation formula for the third line segment p3. However, during the process that the processor 20 gets the estimation formula corresponding to any line segment, one sensing point used for calibration is first arranged on the line segment. The sensing point used for calibration is one of the expected estimated plane points. The sensor 10 is used for sensing the sensed value corresponding to the sensing point used for calibration. The processor 20 calculates a plurality of estimated values corresponding to the sensing point used for calibration on the line segment by using each estimation formula, so as to get the estimation formula for the line segment according to a comparison result of the estimated value with the sensed value. However, if the difference between each estimated value and the sensed value exceeds a preset error threshold, the processor 20 temporarily modifies the estimation formula for any boundary line, adjusts the estimated values of all expected estimated boundary points on the boundary line according to the modified estimation formula, and then calculate whether the difference between the estimated value corresponding to the sensing point used for calibration and the sensed value again is within the above preset error threshold. Once the difference between the estimated value corresponding to the sensing point used for calibration and the sensed value falls within the preset error threshold, the estimation formula temporarily modified for use previously is used to get the estimation formula previously used for boundary line.

When all expected estimated plane points have been estimated, to confirm whether all used estimation formulas are suitable or need to be modified, a sensing point used for calibration may be used for calibration. The sensing point used for calibration may be one of a plurality of expected estimated plane points. The sensor 10 senses the sensed value of the sensing point used for calibration at the location of the sensing point used for calibration. Subsequently, the processor 20 may determine whether the difference between the sensed value of the sensing point used for calibration and the estimated value of the expected estimated plane point corresponding to the sensing point used for calibration exceeds a preset error threshold; when yes, selects any one of the four boundary lines r1 to r4 to modify the estimation formula used for the sensor 10 to estimate the estimated value of the expected estimated boundary point, estimates the estimated value of the expected estimated boundary point and the estimated values of a plurality of expected estimated plane points according to the modified estimation formula, and when determining that the difference between the estimated value of the expected estimated plane point calculated by the modified estimation formula and corresponding to the sensing point used for calibration and the sensed value of the sensing point used for calibration is within the preset error threshold, decides that the estimation formula for the selected boundary line is the modified estimation formula.

Similarly, the sensing point used for calibration may also be an expected estimated boundary point on one of the four boundary lines. The sensor 10 senses the sensed value of the sensing point used for calibration, and then the processor 20 determines whether the difference between the sensed value of the sensing point used for calibration and the estimated value of the expected estimated boundary point corresponding to the sensing point used for calibration exceeds a preset error threshold, when exceeding, modifies the estimation formula for the boundary line, estimates the estimated value of the expected estimated boundary point according to the modified estimation formula, and when determining that the difference between the estimated value of the expected estimated boundary point calculated by the modified estimation formula and corresponding to the sensing point used for calibration and the sensed value of the sensing point used for calibration is within the preset error threshold, decides that the estimation formula for the boundary line is the modified estimation formula.

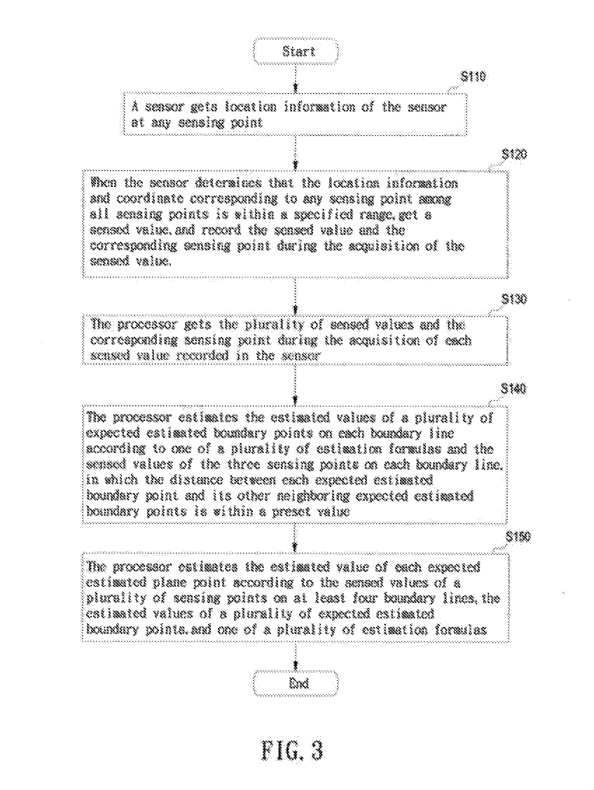

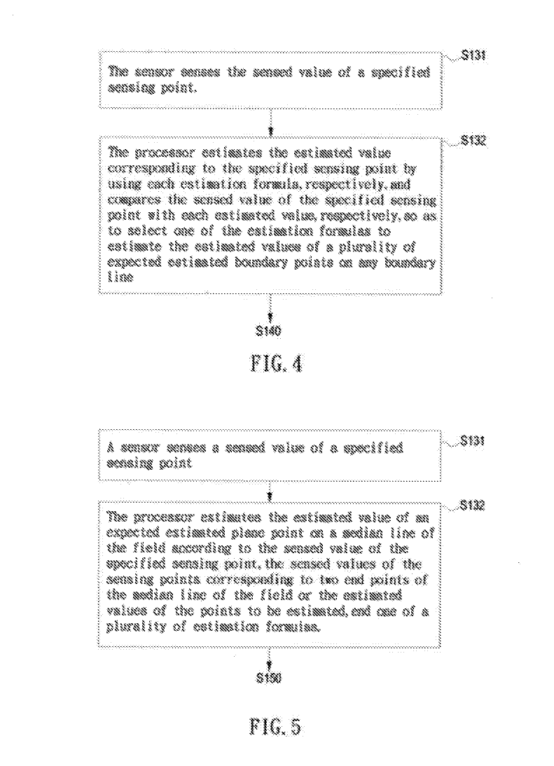

FIG. 3 is a schematic flow chart of a sensing method according to an embodiment of the present invention. FIG. 4 and FIG. 5 are detailed schematic flow charts of a sensing method according to the embodiments of the present invention. Please refer to FIG. 3, FIG. 4, and FIG. 5 in combination with FIG. 1 and FIG. 2 for ease of understanding. The method is applicable to a sensing area formed of at least four boundary lines, in which each boundary line forms a straight angle with other boundary lines connected thereto, each boundary line is at least three sensing points are set on it, and each sensing point implies a coordinate on XY plane. The method at least includes the following Steps:

A sensor 10 gets location information of the sensor 10 at any sensing point (Step S110). The locating unit 12 generates one piece of location information according to the current location of the sensor 10.

When the sensor 10 determines that the location information and coordinate corresponding to any sensing point among all sensing points is within a specified range, get a sensed value, and record the sensed value and the corresponding sensing point during the acquisition of the sensed value (Step S120).

The storage unit 13 stores the coordinates on XY plane corresponding to each sensing point. When the processing unit 14 determines that the distance between the location information provided by the locating unit 12 and the coordinate of one sensing point is within one distance range, the processing unit 14 launches the sensing unit 11 to perform sensing, gets the sensed value provided by the sensing unit 11, and corresponds the sensed value to the sensing point of the current location, which are recorded in the storage unit 13 or a memory space thereof.

The processor 20 gets the plurality of sensed values and the corresponding sensing point during the acquisition of each sensed value recorded in the sensor 10 (Step S130). The processor 20 may communicate with the sensor 10 in any link manner, and gets from the sensor 10 the sensed value corresponding to each sensing point above.

The processor 20 estimates the estimated values of a plurality of expected estimated boundary points on each boundary line according to one of a plurality of estimation formulas and the sensed values of the three sensing points on each boundary line, in which the distance between each expected estimated boundary point and its other neighboring expected estimated boundary points is within a preset value (Step S140).

The processor 20, during Step S140, before performing estimation computation on expected estimated boundary points first, first analyzes the estimation formula corresponding to the current boundary line, and the steps are as follows.

The sensor 10 senses the sensed value of a specified sensing point (Step S131). The specified sensing point is set on any boundary line and corresponds to one of the plurality of sensing points or expected estimated boundary points on any boundary line. When it is assumed that the processor 20 intends to get the estimation formula for the first boundary line r1 in the X-axis direction, the processor 20 gets from the sensor 10 sensed values corresponding to the sensing point a1, the sensing point a2, and the sensing point a3. The processor 20 sets any one of the sensing point a1, the sensing point a2, and the sensing point a3 as the specified sensing point.

The processor 20 estimates the estimated value corresponding to the specified sensing point by using each estimation formula, respectively, and compares the sensed value of the specified sensing point with each estimated value, respectively, so as to select, one of the estimation formulas to estimate the estimated values of a plurality of expected estimated boundary points on any boundary line (Step S132).

By taking the specified sensing point being the sensing point a2 as an example, the processor 20 first gets the sensed value corresponding to the sensing point a2, calculates the estimated value of the sensing point a2 by using each estimation formula and the sensed values of the sensing point a1 and the sensing point a3, respectively, compares the estimated value with the practical sensed value of the sensing point a2 to find the estimated value closest to the sensed value corresponding to the sensing point a2, so as to use the estimation formula corresponding to the estimated value as the estimation formula for the boundary line of the sensing point a2. Similarly, the estimation formulas for all boundary lines are found, and the estimated values corresponding to all expected estimated boundary points on each boundary line are then found according to each boundary line and the corresponding estimation formula for the boundary line.

Subsequently, the processor 20 estimates the estimated value of each expected estimated plane point according to the sensed values of a plurality of sensing points on at least four boundary lines, the estimated values of a plurality of expected estimated boundary points, and one of a plurality of estimation formulas (Step S150). The sensing area further has a specified sensing point, the location of the specified sensing point is in the sensing area, and the specified sensing point is located at a median line of the field that is parallel to any one of the at least four boundary lines and whose two end points are located at other two boundary lines, and the median line of the field has a plurality of expected estimated plane points. The step includes the following detailed procedures:

The sensor 10 senses the sensed value of a specified sensing point (Step S141). By taking FIG. 2 as an example, after the estimated values of points to be estimated on all boundary lines (for example, r1 and r4) have been estimated, a specified sensing point (for example, s2) may be further set in the sensing area. The specified sensing point is located at a median line of the field (for example, p2). The median line of the field is a median line of the field (for example, p2) that is parallel to one boundary line (for example, r2) of the at least four boundary lines and whose two end points are located at other two boundary lines (for example, r1 and r3). The median line of the field may further have a plurality of expected estimated plane points (for example, s1 and s3). The sensor 10 is used for sensing the sensed value of the specified sensing point (s2).

The processor 20 estimates the estimated value of an expected estimated plane point on a median line of the field according to the sensed value of the specified sensing point, the sensed values of the sensing points corresponding to two end points of the median line of the field or the estimated values of the points to be estimated, and one of a plurality of estimation formulas (Step S142).

By taking FIG. 2 as an example for illustration, the processor 20 may estimate the estimated values of the expected estimated plane points (for example, s1 and s3) on the median line of the field (for example, p2) according to the sensed value of the specified sensing point (s2), the sensed values (which may also be the estimated values of the estimated points) of the sensing points corresponding to two end points (for example, a2 and c2) of the median line of the field (for example, p2), and one of a plurality of estimation formulas. In this manner, the median line of the field may be seen as the boundary line of a sensing area of a smaller range, and in combination with the manner of calculating the estimated value corresponding to the expected estimated plane point on the median line of the field, the estimated values of the expected estimated plane points in the sensing area are gradually estimated.

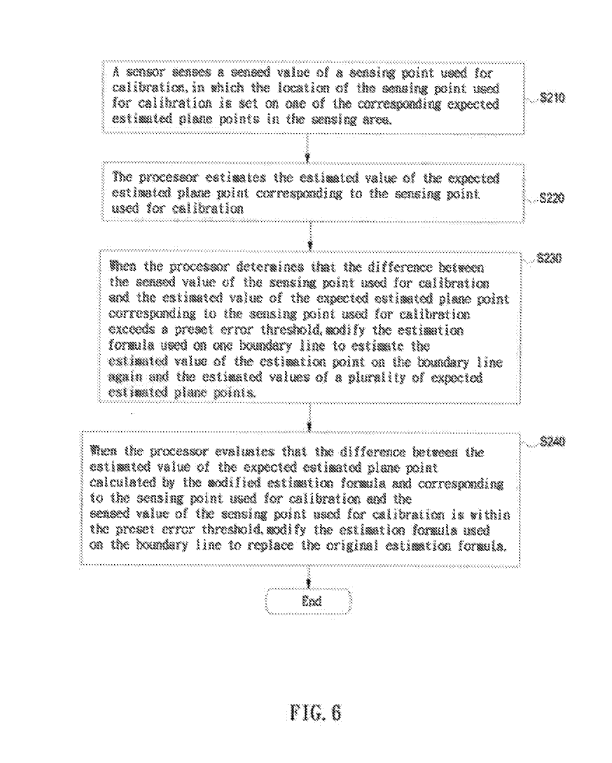

FIG. 6 is a schematic flow chart of a sensing calibration method according to an embodiment of the present invention. Please refer to FIG. 6, the method is applicable to the calibration of a sensed value and is illustrated as follows.

A sensor 10 senses a sensed value of a sensing point used for calibration, in which the location of the sensing point used for calibration is set on one of the corresponding expected estimated plane points in the sensing area (Step S210). The sensing area formed by the second boundary line r2, the third boundary line r3, the first line segment p1, and the second line segment p2 intersecting with each other is taken as an example. The processor 20 arranges a sensing point used for calibration on a third line segment p3 formed by connecting the expected estimated boundary point b3 and the expected estimated plane point s1, in which the sensing point used for calibration is any one of the corresponding expected estimated plane points on the third line segment p. The sensor 10 is used for sensing the sensed value corresponding to the sensing point used for calibration.

The processor 20 estimates the estimated value of the expected estimated plane point corresponding to the sensing point used for calibration (Step S220). In a manner similar to the above, the processor 20 estimates multiple estimated values corresponding to the sensing point used for calibration by using multiple estimation manners in combination with the sensed value corresponding to the expected estimated boundary point b3 and the estimated value corresponding to the expected estimated plane point s1.

When the processor 20 determines that the difference between the sensed value of the sensing point used for calibration and the estimated value of the expected estimated plane point corresponding to the sensing point used for calibration exceeds a preset error threshold, modify the estimation formula used on one boundary line to estimate the estimated value of the estimation point on the boundary line again and the estimated values of a plurality of expected estimated plane points (Step S230).

The processor 20 compares the estimated value corresponding to the sensing point used for calibration with the sensed value to find the estimation formula for the third line segment p3. However, if the difference between the estimated value corresponding to the sensing point used for calibration and the sensed value exceeds the preset error threshold, the processor 20 adjusts either of the estimation formulas for the second line segment p2 and the second boundary line r2 again to calculate the estimated values of all estimation points on the second line segment p2 or the second boundary line r2 again.

When the processor 20 evaluates that the difference between the estimated value of the expected estimated plane point calculated by the modified estimation formula and corresponding to the sensing point used for calibration and the sensed value of the sensing point used for calibration is within the preset error threshold, modify the estimation formula used on the boundary line to replace the original estimation formula (Step S240). The processor 20 calculates the estimated value of the sensing point used for calibration again and compares the estimated value with the sensed value of the sensing point used for calibration. When the processor 20 computes that the difference between the sensed value corresponding to the sensing point used for calibration and the estimated value falls within the preset error threshold, a new estimation formula is used to replace the originally used estimation formula.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A sensing system, applicable to a sensing area formed of at least four boundary lines, wherein each boundary line forms a straight angle with other boundary lines connected thereto, at least three sensing points are set on each boundary line, each sensing point implies a coordinate on XY plane, and the system comprises:
at least one sensor, comprising:
a sensing unit, used for providing a sensed value,
a locating unit, used for generating location information of the sensor,
a storage unit, used for storing the sensing points and coordinates corresponding thereto, and
a processing unit, used for, when it is determined that the location information and the coordinate of one sensing point among the sensing points is within a specified range, launching the sensing unit to get the sensed value, and recording the sensed value and the corresponding sensing point when the sensing unit is launched; and
a processor, coupled to the at least one sensor to get the recorded plurality of sensed values and sensing points corresponding to the sensed values, and used for estimating estimated values of a plurality of expected estimated boundary points on each boundary line according to one of a plurality of estimation formulas and the sensed values of the three sensing points on each boundary line, wherein a distance between each expected estimated boundary point and its other neighboring expected estimated boundary points is within a preset value.

2. The sensing system according to claim 1, wherein a plurality of expected estimated plane points is set in the sensing area, and the processor is further used for estimating an estimated value of each expected estimated plane point according to the sensed values of the plurality of sensing points on the at least four boundary lines and the estimated values of the plurality of expected estimated boundary points, and one of a plurality of estimation formulas.

3. The sensing system according to claim 1, wherein the sensing area further has a specified sensing point, the location of the specified sensing point is in the sensing area, the specified sensing point is located at a median line of the field that is parallel to one of the at least four boundary lines and whose two end points are located at other two boundary lines, the median line of the field has a plurality of expected estimated plane points, the at least one sensor is further used for sensing a sensed value of the specified sensing point, and the processor is further used for estimating an estimated value of the expected estimated plane point on the median line of the field according to the sensed value of the specified sensing point, sensed values of sensing points corresponding to two end points of the median line of the field or the estimated values of the points to be estimated, and one of a plurality of estimation formulas.

4. The sensing system according to claim 3, wherein one of the expected estimated plane points is a sensing point used for calibration, the at least one sensor is further used for sensing a sensed value of the sensing point used for calibration, the processor is further used for, when it is determined that a difference between the sensed value of the sensing point used for calibration and an estimated value of an expected estimated plane point corresponding the sensing point used for calibration exceeds a preset error threshold, selecting a boundary line among the at least four boundary lines, modifying the estimation formula used for the processor to estimate the estimated values of the expected estimated boundary points, estimating the expected estimated boundary points of selected boundary lines and the expected estimated plane points according to the modified estimation formula, and when it is determined that the difference between an estimated value of the expected estimated plane point calculated by the modified estimation formula and corresponding to the sensing point used for calibration and the sensed value of the sensing point used for calibration is within the preset error threshold, deciding the estimation formula for the selected boundary line as the modified estimation formula.

5. The sensing system according to claim 1, wherein one boundary line among the at least four boundary lines further comprises a specified sensing point corresponding to one of the plurality of sensing points on the one boundary line, and the processor is further used for estimating an estimated value corresponding the specified sensing point by using each estimation formula, respectively, and comparing the sensed value of the specified sensing point with each estimated value respectively, so as to select one of the estimation formulas to estimate the estimated values of the plurality of expected estimated boundary points on each boundary line.

6. The sensing system according to claim 1, wherein one boundary line among the at least four boundary lines further comprises a sensing point used for calibration corresponding to one of the plurality of expected estimated boundary points of the boundary line, the at least one sensor is further used for sensing a sensed value of the sensing point used for calibration, and the processor is further used for determining whether a difference between the sensed value of the sensing point used for calibration and the estimated value of the expected estimated boundary point corresponding to the sensing point used for calibration exceeds a preset error threshold, when exceeding, modifying the estimation formula for the boundary line, estimating the estimated value of the expected estimated boundary point by the modified estimation formula, and when it is determined that the difference between an estimated value of the expected estimated boundary point calculated by the modified estimation formula and corresponding to the sensing point used for calibration and the sensed value of the sensing point used for calibration is within the preset error threshold, deciding that the estimation formula for the boundary line is the modified estimation formula.

7. The sensing system according to claim 1, wherein one of the sensing points of the boundary lines is set on the intersection of two neighboring boundary lines among the boundary lines and seen as the sensing points of the two neighboring boundary lines at the same time.

8. The sensing system according to claim 1, wherein one of the expected estimated boundary points is set on the intersection of two neighboring boundary lines among the boundary lines, the processor estimates two estimated values related to the expected estimated boundary point set on the intersection of two neighboring boundary lines by respectively using the estimation formulas of the two neighboring boundary lines, and uses the mean value of the two estimated values as the estimated value of one of the expected estimated boundary points.

9. A sensing method, applicable to a sensing area formed of at least four boundary lines, wherein each boundary line forms a straight angle with other boundary lines connected thereto, each boundary line is at least three sensing points are set on it, each sensing point implies a coordinate on XY plane, and the method comprises:
getting, by a sensor, location information of the sensor at any sensing point;
when the sensor determines that the location information and the coordinate of one sensing point among the sensing points is within a specified range, getting a sensed value, and recording the sensed value and the corresponding sensing point during the acquisition of the sensed value;
getting, by a processor, a plurality of sensed values and the corresponding sensing points during the acquisition of the sensed values recorded in the sensor; and
estimating, by the processor, estimated values of a plurality of expected estimated boundary points on each boundary line, according to one of a plurality of estimation formulas and the sensed values of the three sensing points on each boundary line, wherein a distance between each expected estimated boundary point and its other neighboring expected estimated boundary points is within a preset value.

10. The sensing method according to claim 9, wherein the sensing area is set with a plurality of expected estimated plane points, and after the step of estimating the estimated values of the plurality of expected estimated boundary points with a distance not exceeding a preset value on each boundary line, the method further comprises:
estimating, by the processor, an estimated value of each expected estimated plane point according to the sensed values of the plurality of sensing points on the at least four boundary lines, the estimated values of the plurality of expected estimated boundary points and one of a plurality of estimation formulas.

11. The sensing method according to claim 9, wherein the sensing area further has a specified sensing point, the location of the specified sensing point is located in the sensing area, the specified sensing point is located at a median line of the field that is parallel to one of the at least four boundary lines and whose two end points are located at other two boundary lines, the median line of the field has a plurality of expected estimated plane points, and the method further comprises:
sensing, by the at least one sensor, a sensed value of the specified sensing point; and,
estimating, by the processor, estimated values of expected estimated plane points on the median line of the field according to the sensed value of the specified sensing point, sensed values of sensing points corresponding to two end points of the median line of the field or the estimated values of the points to be estimated, and one of a plurality of estimation formulas.

12. The sensing method according to claim 11, wherein one of the expected estimated plane points is a sensing point used for calibration, and the method further comprises:
sensing, by the at least one sensor, a sensed value of the sensing point used for calibration; and
selecting, by the processor, one boundary line among the at least four boundary lines when it is determined that the difference between the sensed value of the sensing point used for calibration and the estimated value of the expected estimated plane point corresponding to the sensing point used for calibration exceeds a preset error threshold, modifying the estimation formula used for the processor to estimate the estimated value of the expected estimated boundary point, estimating the estimated value of the expected estimated boundary point and the estimated values of the plurality of expected estimated plane points according to the modified estimation formula, and when it is determined that the difference between an estimated value of the expected estimated plane point calculated by the modified estimation formula and corresponding to the sensing point used for calibration and the sensed value of the sensing point used for calibration is within the preset error threshold, deciding that the estimation formula for the selected boundary line is the modified estimation formula.

13. The sensing method according to claim 9, wherein one boundary line among the at least four boundary lines further comprises a specified sensing point corresponding to one of the plurality of sensing points on the one boundary line, and the method further comprises:
estimating, by the processor, an estimated value corresponding to the specified sensing point by using each estimation formula, respectively, and comparing the sensed value of the specified sensing point and each estimated value, respectively, so as to select one of estimation formulas to estimate the estimated values of a plurality of expected estimated boundary points on any boundary line.

14. The sensing method according to claim 9, wherein one boundary line among the at least four boundary lines further comprises a sensing point used for calibration corresponding to one of the plurality of expected estimated boundary points on the boundary line, and the method further comprises:
sensing, by the at least one sensor, a sensed value of the sensing point used for calibration; and
determining, by the processor, whether the difference between the sensed value of the sensing point used for calibration and the estimated value of the expected estimated boundary point corresponding to the sensing point used for calibration exceeds a preset error threshold, when exceeding, modifying the estimation formula for the boundary line, estimating the estimated value of the expected estimated boundary point according to the modified estimation formula, and when it is determined that the difference between an estimated value of the expected estimated boundary point calculated by the modified estimation formula and corresponding to the sensing point used for calibration and the sensed value of the sensing point used for calibration is within the preset error threshold, deciding that the estimation formula of the boundary line is the modified estimation formula.

15. The sensing method according to claim 9, wherein one of the sensing estimation points of the boundary lines is set on the intersection between two neighboring boundary lines among the boundary lines, and seen as the sensing points for the two neighboring boundary lines at the same time.

16. The sensing method according to claim 9, wherein one of the expected estimated boundary points is set on the intersection of two neighboring boundary lines among the boundary lines, the processor estimates two estimated values related to the expected estimated boundary point set on the intersection respectively by using the estimation formulas respectively corresponding to the two neighboring boundary lines, and uses the mean value of the two estimated values as the estimated value of one of the expected estimated boundary points.

17. A non-immediately recording medium, storing a computer program code readable by an electronic device, wherein the electronic device, when reading the computer program, executes a sensing method by using the at least one sensor and the at least one processor, so as to be applicable to a sensing area formed of at least four boundary lines, each boundary line forms a straight angle with other boundary lines connected thereto, each boundary line is at least three sensing points are set on it, each sensing point implies a coordinate on XY plane, and the sensing method comprises:
getting, by the sensor, location information at any sensing point;
when the sensor determines that the location information and the coordinate of one sensing point among the sensing points is within a specified range, getting a sensed value, and recording the sensed value and the corresponding sensing point during the acquisition of the sensed value;
getting, by the processor, a plurality of sensed values and the corresponding sensing points during the acquisition of the sensed values recorded in the sensor; and
estimating, by the processor, estimated values of a plurality of expected estimated boundary points with a distance not exceeding a preset value on each boundary line according to one of a plurality of estimation formulas and the sensed values of the three sensing points on each boundary line.
